(19) United States
(12) Patent Application Publication
(10) Pub. No.: US 2004/0114538 A1
(43) Pub. Date: Jun. 17, 2004

(54) Device roles and piconet connections

(76) Inventor: Stephane Bouet, Kanagawa-ken (JP)

Correspondence Address: MORGAN & FINNEGAN, L.L.P., 345 PARK AVENUE, NEW YORK, NY, 10154, US

(21) Appl. No.: 10/250,514

(22) PCT Filed: Nov. 29, 2001
(86) PCT No.: PCT/FI01/01039

(30) Foreign Application Priority Data
Dec. 27, 2000 (FI) 20002860

(51) Int. Cl. H04L 12/28

(52) U.S. Cl. 370/254

(57) ABSTRACT

The invention discloses a technique that enables a device lacking master-slave switch capability to establish a connection with a piconet and becoming a slave. The invention is particularly suitable for applications where a role exchange is required, such as when a requesting device attempts to access a Bluetooth LAN access gateway where the gateway needs to maintain master status and the device slave status. In an embodiment of the invention, a first device sends an inquiry (300) to a second device followed and receives identifying information of the second device. The first device pages (310) the second device using the received identifying information to establish a first connection thereby establishing the first device master of an ensuing piconet. The first device terminates (320) the first connection which signals to the second device to initiate a connection with the first device. The second device pages (325) the first device using the identifying information from the previous inquiry (300) to establish a second connection (330) and thereby making the second device the master and the first device a slave in the piconet.

### FIELD OF INVENTION

The present invention relates generally to field of wireless telecommunications and, more particularly, to the establishment of connections with devices lacking role exchange capability in the establishment of a piconet especially although not necessarily with devices using Bluetooth connection technology.

### BACKGROUND OF THE INVENTION

The concept of short-range wireless communications has gained increasing interest in recent years. The popularity of handheld devices such as mobile phones and PDAs have increased the need for connectivity between these devices and with computing resources such as wireless LANs. One proposed solution for connections of this sort that uses low power wireless links is Bluetooth. Bluetooth is a communications standard for short-range radio connections that allow communication with mobile devices, computers and peripherals in an ad-hoc fashion. Bluetooth enables voice and data transfer between communication devices and computing devices within a range of about 10 to 100 meters. Since it is based on radio technology, a significant advantage is that it allows for the elimination of cables that normally connect devices and peripherals to be replaced by a universal short-range radio link. And due to its RF nature, the devices do not need to be within line-of-sight of each other which allow connections through walls or other non-metal objects, as opposed to infrared. This enables mobile phones to be especially suitable for use with Bluetooth where they could, for example, operate as a modem for a laptop or PDA to further enhance mobility.

Networking connections in Bluetooth are established in an ad hoc fashion in what are referred to as piconets. A piconet is the feature of the Bluetooth specification that allows for networking among two or more devices over radio connections in a point-to-point or point-to-multipoint network with up to eight total devices. The piconet is structured in a hierarchical arrangement which is composed of one master and one or more slaves. The master device controls the slaves in the piconet by, for example, controlling the frequency-hopping sequence and allocating the data and voice channels for the duration of the piconet connection.

FIG. 1 illustrates the structure of an exemplary Bluetooth piconet. In the piconet, the master device M controls a variety of slave devices S1 through Sn (where n equals seven or less) via individual wireless connections. A typical application could include a desktop computer as the master connected to slave devices such as a keyboard, mouse and printer using Bluetooth wireless links. It is conceivable that two or more independent and non-synchronized piconets come into contact with each other which have overlapping coverage areas and thus interfere. Such a situation may occur, for example, when a piconet consisting of a Bluetooth enabled mobile phone and an associated Bluetooth compatible headset comes into the proximity of the computer/keyboard piconet of FIG. 1. The scenario when at least one device is common to both piconets is referred to as a scatternet (or inter-piconet) in the Bluetooth specification. A scatternet is created when a single device is a master in one piconet and a slave in one or more other piconets. Another form of scatternet occurs when a Bluetooth unit is a slave in multiple piconets. Scatternets can lead to relatively complex device relationships which requires the affected devices to switch between different time bases, different access words and encryption keys associated with each piconet.

An important feature of Bluetooth networking for supporting piconets is the ability to perform a role exchange or a master-slave switch. The Bluetooth specification allows for the roles of the piconet master and slave to be reversed. This feature is particularly important because it enables a new device to join an existing piconet when it pages the piconet's master. An interim piconet is established with the new device becoming the master and the paged unit as the slave. To add the new device into the existing piconet, the paged unit must then initiate a master-slave switch to reverse the roles. In another example, a master-slave switch is necessary in situations where e.g. a Bluetooth compliant mobile phone wishes to connect to a Bluetooth LAN access point (or gateway) in order to gain access to a Local Area Network (LAN) in an office environment, for example. The switch is necessary because the LAN access gateway must retain its master role so that it can continue to direct data traffic to the various devices connected to the LAN.

The master-slave switch feature as outlined in the Bluetooth specification, is optional and therefore it is expected, at least initially, that there may be many devices shipped without support for this feature. This may be especially the case for low-end devices such as mobile phones and PDAs, for example. A problem occurs when a device that lacks the master-slave switch capability enters into a scenario where a role exchange is required, such as when attempting to access a Bluetooth LAN access gateway for example. In the current implementation, devices that are unable to perform the switch will not be successful in obtaining access to the desired resources. Furthermore, even an unsuccessful connection attempt by a device impacts surrounding devices that do not wish to connect to that device by forcing them to respond to an inquiry associated with the connection attempt.

In view of the foregoing, it is an objective of the present invention to provide a technique that enables a Bluetooth device without role exchange capability to successfully establish a connection with a piconet without having to take on the role of master. Furthermore, the technique eliminates the burden forced inquiry responses by unrelated surrounding devices.

### SUMMARY OF THE INVENTION

Briefly described and in accordance with an embodiment and related features of the invention, there is provided a method of performing a master-slave role exchange between a first device and a second device following the establishment of a piconet, the method comprising the steps of:

sending an inquiry command by the first device to discover the second device.

paging the second device by the first device in establishing a first connection, and wherein the establishment of the first connection would establish the first device as a master and the second device as a slave;

terminating the first connection by the first device;

paging the first device by the second device; and

establishing a second connection by the second device with the first device thereby establishing a piconet with the second device as master and the first device as a slave.

In a system aspect there is provided a wireless network system comprising a master device and a client device in communication within a piconet, and wherein said master device controls the client device in the piconet, said system comprises:

means for the client device to send an inquiry to the master device;

means for the client device to page the master device;

means for the client device to terminate a connection ensuing from said page;

means for the master device to discern from said terminated connection that the master device should initiate a connection with the client device; and

means for the master device to page the client device and establish a connection with the client device.

### BRIEF DESCRIPTION OF THE DRAWINGS

The invention, together with further objectives and advantages thereof, may best be understood by reference to the following description taken in conjunction with the accompanying drawings in which:

FIG. 1 illustrates the structure of an exemplary Bluetooth piconet;

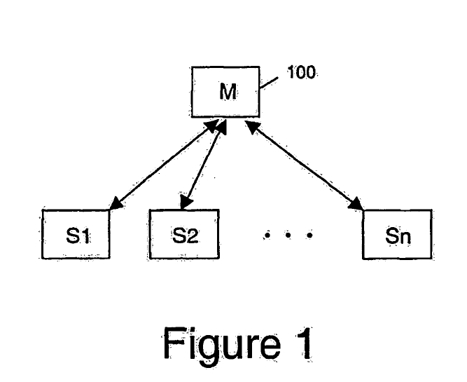

FIG. 2 illustrates the steps for a typical Bluetooth device with role exchange capability for establishing a connection to an existing piconet;

FIG. 3 illustrates an exemplary inquiry sequence;

FIG. 4 illustrates an exemplary paging sequence; and

FIG. 5 illustrates the steps taken in accordance with an embodiment of the invention for a device that lacks role exchange capability to join an established piconet.

### DETAILED DESCRIPTION OF THE INVENTION

As described in the preceding sections, without role switching capability may present problems when trying to establish connections with devices or piconets that require an exchange. Indeed, in the gateway scenario, an alternative solution to the problem where the device lacks master-slave switching capability would be for the Gateway to perform numerous systematic inquiries and open up connections with all discovered surrounding devices. However, this would have a huge impact on resources since all surrounding devices would be disturbed to respond and connect with the gateway. The invention is directed toward a solution that allows the connection initiative to come from the slave device thereby eliminating the unnecessary impact on surrounding devices.

A Bluetooth compatible device with the role exchange capability that encounters a situation where a master-slave switch is necessary is able to join an existing piconet and attain slave status after a role exchange. In the example of the Bluetooth LAN access point, the connection between a client device with the Bluetooth access point is performed in accordance with the link management protocol (LMP) defined for use in Bluetooth. The LMP is used in Bluetooth between devices to control link establishment, manage security, and to provide general control services such as power management etc. Furthermore, LMP is used for link setup, control, and authentication for a device attempting to establish Bluetooth a connection or join an existing piconet.

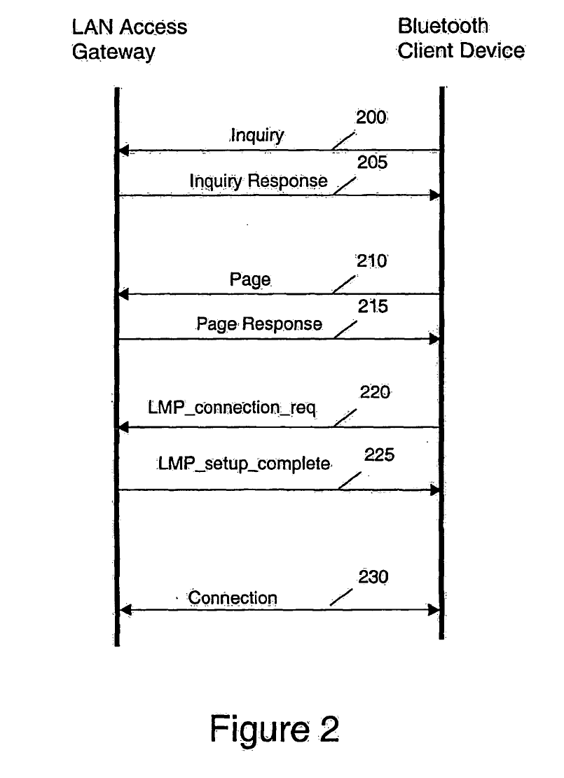

FIG. 2 illustrates the typical signaling steps taken for a Bluetooth client device (e.g. a mobile terminal) with role exchange capability for establishing a connection to an existing piconet such as a Bluetooth wireless LAN access gateway. The first step involves an inquiry command 200 sent out by the Bluetooth client device to discover all surrounding devices including the LAN access gateway. The inquiry command prompts a response by the surrounding Bluetooth devices, i.e. the LAN access gateway, that are within radio range, as shown by reference numeral 205. The gateway then pages 210 the client device and the device responds with a page response 215. The gateway responds by sending a frequency hopping and synchronization (FHS) packet which includes the baseband address and clock offset information in the page response 215. The gateway sends an LMP_connection_req 220 and the client device responds with an LMP_setup_complete 225 where a connection 230 is established. The connection established is a high level connection using protocols such as RFComm or TCS Binary which are particularly suitable for speech and data connections between Bluetooth units.

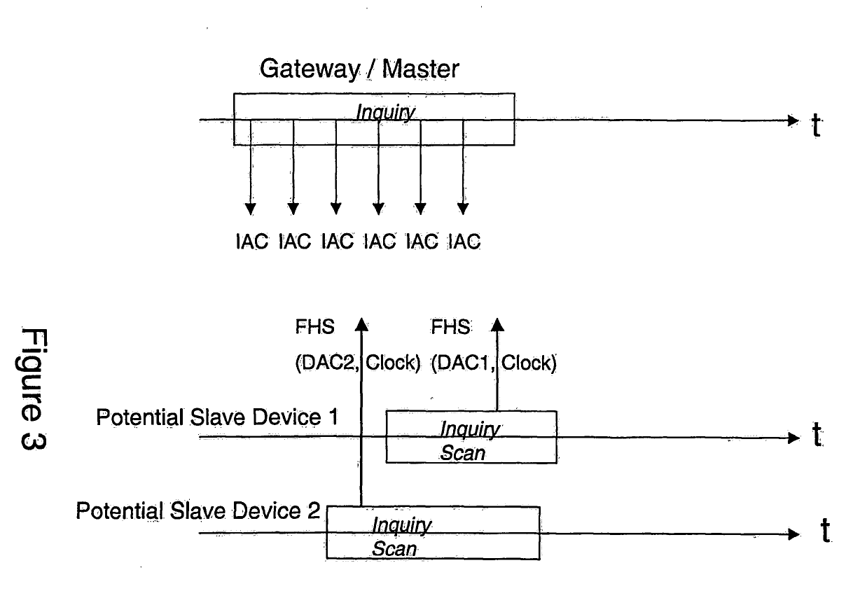

FIG. 3 illustrates an exemplary inquiry sequence in Bluetooth technology. The device (marked by reference Gateway/Master) that is about to become Master issues an inquiry packet with one of the 2 possible tags (called inquiry access codes, IAC), GIAC or DIAC. In response to this inquiry, devices (marked by references Potential Slave Device 1 and Potential Slave Device 2) that are in the inquiry scan state reply by sending back to the Master an FHS packet that includes their identity (called Devices Access Code or DAC), their clock information and some other parameters that can be used as device filtering parameters by the Master, if needed and desirable. The DAC is the minimum necessary in order for the Master to be able to page later to a client. Knowledge of the Clock offset information makes the paging procedure faster. The notations inquiry/inquiry response on FIG. 2 are schematic representations of the above process.

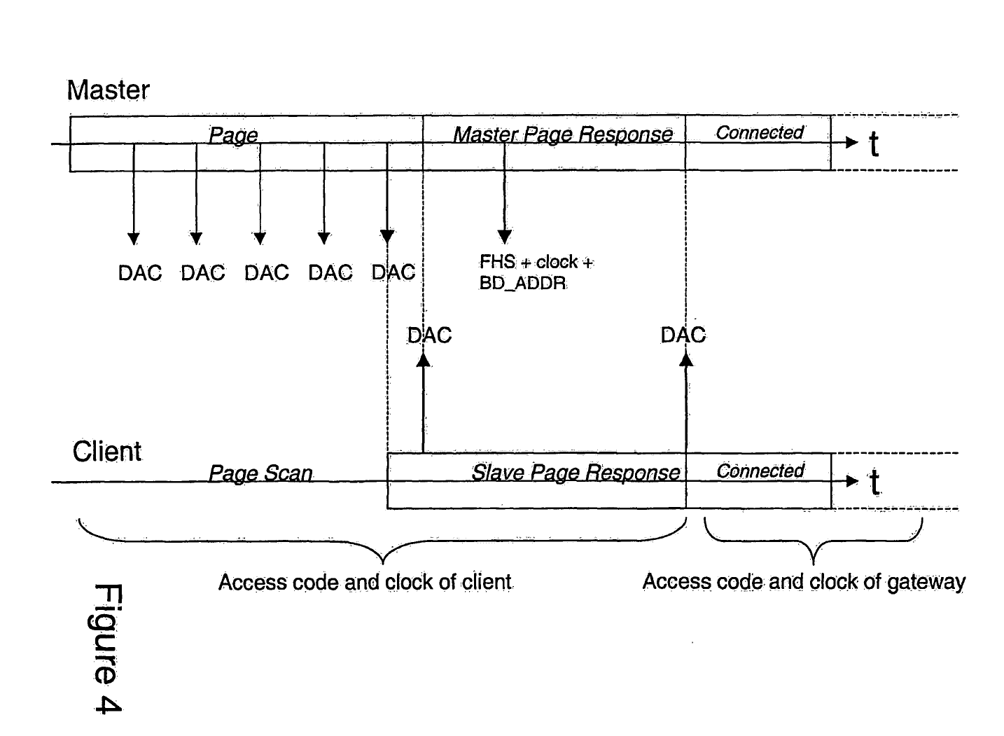

In a Gateway/Client device configuration, inquiries are typically issued by the clients that want to connect to the Gateway, using the GIAC. The gateway responds back with a FHS packet. The client then proceeds to the paging process as described in FIG. 4.

FIG. 4 illustrates an exemplary paging sequence in Bluetooth technology. The device (marked by reference Master) that is to become Master first “wakes up” the potential slave by sending a page packet that carries the DAC of the target device. The target device (marked by reference Client) then immediately responds by issuing the same packet back to the Master. The Master then sends an FHS packet containing its device access code and clock offset information, for the target device to be able to calculate the relevant FHS and lock on it. The target acknowledges reception by sending back the original paging packet again. The link is then achieved. It should be noted that the notations page/page response on FIG. 2 are schematic representations of the above process)

In the Gateway/Client device configuration as described above, the client that wishes to connect to the Gateway pages the Gateway and opens the link with the Gateway. This is normally followed by a Master-Slave switch procedure that allows the Gateway to take on the role of Master and the client to goes back to a Slave role. Since the device that establishes the connection automatically becomes a master, a role exchange is performed so that the gateway can regain master status with the client device becoming a slave. The preservation of the original roles is paramount since the access gateway's primary function is to serve several devices by directing incoming traffic and controlling the addition of new devices to the piconet which can only be performed with master status.

As outlined in the foregoing procedure, the customary way for a device to connect to a Bluetooth LAN access gateway is to page the gateway to establish a piconet whereby a subsequent role exchange occurs such that the device becomes a slave controlled by the gateway. As can be surmised, the technique is highly contingent upon the fact that the requesting device is capable of performing the role exchange as such. In accordance with an embodiment of the present invention, a technique is provided for which a Bluetooth client device, independent of whether it has role exchange capability, can establish a connection with e.g. the LAN access gateway as described above. The technique permits a client device to initiate a connection using standard procedures thereby eliminating the need for significant changes to the Bluetooth infrastructure.

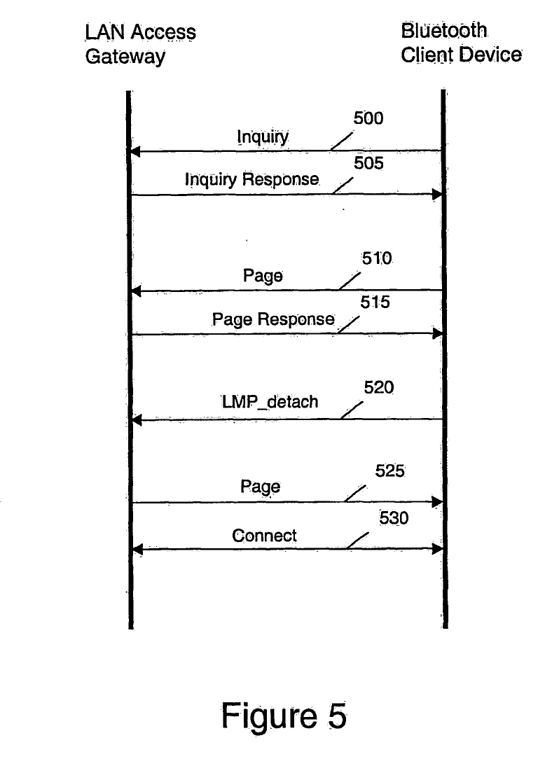

FIG. 5 illustrates the signaling steps taken in accordance with an embodiment of the invention when a client device which lacks role exchange capability attempts to connect to the Bluetooth LAN access gateway. The client device initially behaves in the same way as would when opening a connection with the gateway above the LMP level. The requesting client device begins by performing an inquiry to discover surrounding devices within radio range which hopefully includes the target device i.e. the access gateway, as shown by signal 500. The gateway, which is in discoverable and connectable mode, responds to the inquiry by sending its baseband address and clock offset information to the client in response signal 505. Armed with device identifying information returned from all responding devices, the client device initiates a paging procedure to establish a connection with the gateway, as indicated by paging signal 510. Sent in page 510 to the gateway is information identifying the client device i.e. baseband address and clock synchronization information, among other things. The gateway sends the client a page response indicated by reference numeral 515. The gateway stores the information provided by the client device during the initial inquiry and paging attempts which it can later use to page the client.

The client device at this point, aware that following through with the connection would make it the master of the ensuing piconet and thus would necessitate a role exchange that it is unable to perform, terminates the connection procedure by sending an LMP_detach command in signal 520. The LMP_detach command can be issued by either the master or slave device to close a connection at anytime between two Bluetooth devices. A reason parameter can be included in the message to inform the other party of why the connection was closed which, in this case, is that the client device is not capable of performing a role exchange. After receiving the reason message, the gateway discerns that the client wants the connection to be initiated by the gateway. From the information collected during the previous steps, the gateway pages the client device to initiate a return connection, as shown by signal 525. The act of initiating the connection makes the gateway the master of the piconet and the client device a slave by default. The gateway then establishes a full connection with the client device as shown by signal 530.

The present invention contemplates a technique for devices without role exchange capability to successfully join an established piconet with a primary vocation of being a slave device. This is carried out by initiating two connections in which the first connection provides enough information on the requesting device such that the master of the piconet can return page the requesting device to establish a second connection. An advantage of the invention is that devices not interested in connecting to the piconet are not burdened with the task of issuing an unnecessary response. This is because, as known by those skilled in the art, most surrounding devices perform inquiry scans on the dedicated inquiry access codes. Thus by paging the piconet in the first connection attempt, using the Generic Inquiry Access Code that most surrounding devices ignore, the device specific parameters are obtained which enable the piconet in return page the requesting device without disturbing surrounding devices.

Furthermore, the inventive concept could be used in a very simple way to register a device. By way of example, a device could advertise its presence by just issuing an inquiry/page sequence and terminate it before completion. That would provide enough information to provide one's identity to surrounding devices without having to be informed on the presence of the surrounding devices. As an illustration of an application, one could enter e.g. a museum, where one's device automatically registers according to the inventive concept i.e. perform steps for an inquiry, page, and then abort before link establishment. Then you could walk through the exhibition and you can receive information on your phone from multiple access points spread over the exhibition floor that have received the address and clock offset of your device via the previous registration step.

Although the invention has been described in some respects with reference to a specified embodiment thereof, variations and modifications will become apparent to those skilled in the art. In particular, the invention may be implemented for use in applications other than a LAN access gateway described in the invention. In particular, the inventive concept may be applied any situation where a Bluetooth device can create a piconet but wishes to function as a slave device. It is therefore the intention that the following claims not be given a restrictive interpretation but should be viewed to encompass variations and modifications that are derived from the inventive subject matter disclosed.

1. A method of performing a master-slave role exchange between a first device and a second device following the establishment of a piconet, the method comprising the steps of:
sending an inquiry command by the first device to discover the second device.
paging the second device by the first device in establishing a first connection, and wherein the establishment of the first connection would establish the first device as a master and the second device as a slave;
terminating the first connection by the first device;
paging the first device by the second device; and
establishing a second connection by the second device with the first device thereby establishing a piconet with the second device as master and the first device as a slave.

2. A method according to claim 1 wherein the step of sending an inquiry command by the first device includes receiving, by the first device, identifying parameters of the second device that include address information and clock information.

3. A method according to any of the preceding claims wherein the step of paging the second device by the first device includes receiving, by the second device, identifying parameters of the first device that include address information and clock information.

4. A method according to any of the preceding claims wherein in the step of paging the first device by the second device, the second device uses the address information and clock information of the first device to page the first device.

5. A method according to any of the preceding claims wherein the first device terminates the first connection and sends a reason message to the second device which notifies the second device to initiate a connection with the first device.

6. A method according to claim 1 wherein the first device and the second device establish a piconet operating in accordance with standard Bluetooth communication protocols.

7. A wireless network system comprising a master device and a client device in communication within a piconet, and wherein said master device controls the client device in the piconet, said system comprises:
means for the client device to send an inquiry to the master device;
means for the client device to page the master device;
means for the client device to terminate a connection ensuing from said page;
means for the master device to discern from said terminated connection that the master device should initiate a connection with the client device; and
means for the master device to page the client device and establish a connection with the client device.

8. A system according to claims 7 wherein the client device lacks the role exchange capability of a master-slave switch with the master device.

9. A system according to claim 7 or 8 wherein the master device further comprises a memory containing software providing the discerning means of the master device for determining when to initiate a connection with the client device.

10. A system according to any claims 7-9 wherein the connection established is a high level connection such as RFCom or TCS-binary.

11. A system according to any of claims 7-10 wherein the master device is a Bluetooth LAN access gateway and the client device is a Bluetooth enabled mobile terminal.
